(19) United States
(12) Patent Application Publication
(10) Pub. No.: US 2007/0266159 A1
(43) Pub. Date: Nov. 15, 2007

(54) System and Method for Communication Between Remote Objects and Local Proxies

(75) Inventors: Jens Doppelhamer, Ladenburg (DE); Eckhard Kruse, Heidelberg (DE); Zaijun HU, Ludwigshafen (DE); Yauheni Veryha, Mannheim (DE)

Correspondence Address: BUCHANAN, INGERSOLL & ROONEY PC, POST OFFICE BOX 1404, ALEXANDRIA, VA, 22313-1404, US

(73) Assignee: ABB Research LTD., Zurich (CH)

(21) Appl. No.: 10/587,471

(22) PCT Filed: Jan. 28, 2005
(86) PCT No.: PCT/EP05/00862

§ 371 Date: Mar. 16, 2007

(30) Foreign Application Priority Data
Jan. 29, 2004 (DE) 10 2004 004 345.0

(51) Int. Cl. G06F 15/173

(52) U.S. Cl. 709/226

(57) ABSTRACT

The invention relates to a system and to a corresponding method for communicating between remote objects provided by service providers (10). The methods thereof are accessible as web services (5) and client-sided local proxies (proxies 3) in a computer network (9), in particular Internet or LAN. A general service (8) is installed in addition to existing services (web services 5) on the side of the service provider (10), said general service being used to connect one or several client (1) service requests to the available services (5), and to transmit one or several answer messages to the clients (1). An optimisation layer (6) is implemented on the client side in addition to the other local proxies (proxies 3), said optimisation layer being configured in order to carry out client-sided optimisation and to combine groups of requests. Also, a general proxy (7) is installed which is configured in order to carry out grouped service requests and to return answer messages to the optimisation layer (6).

The invention relates to a system and a method for communication between remote objects whose methods can be accessed as XML web services—in this case also referred to for short as web services—and their local proxy objects, whose methods implement transparent access to the remote methods. Communication methods such as these are described, for example, in http://www.w3c.org/2002/ws/, (Date: Jan. 27, 2004).

XML web services represent a standardized and widely used basis for communication in loosely coupled, distributed systems, such as the Internet, in particular for calling remote procedures and methods. XML web services can be used to access remote objects in object-oriented systems.

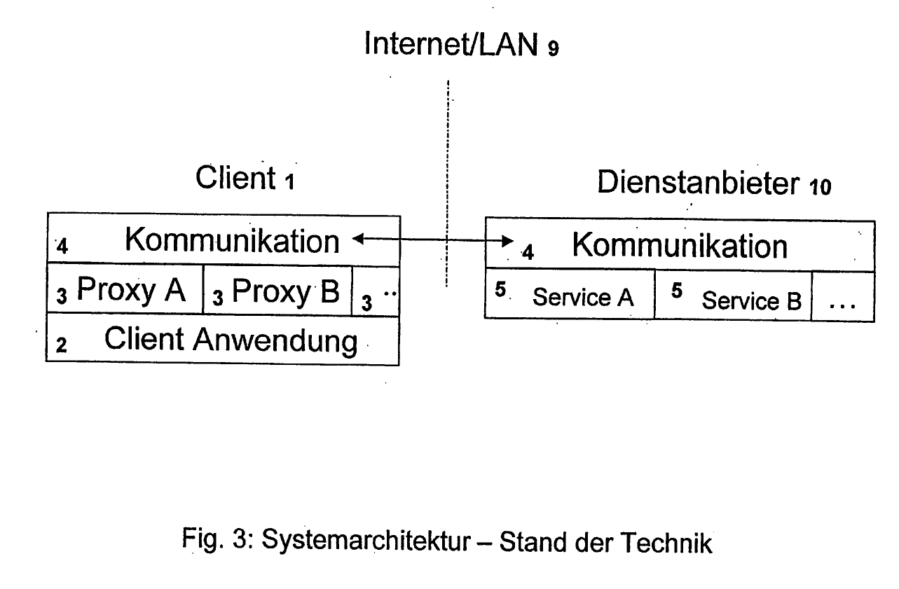

FIG. 3 shows the system architecture of a communications system according to the prior art. This shows a client 1 which communicates with a service provider 10 via the Internet or a LAN 9. The client 1 can be regarded as a data processing device with associated software, with at least one client application 2 which communicates with proxies 3, for example a proxy A and a proxy B, with them in turn communicating with a communication layer 4. The communication layer 4 of the client 1 is designed to communicate with a corresponding communication layer 4 of a service provider 10 via the Internet 9. The facilities of the service provider 10 also include software means for provision of services 5, for example a service A and a service B.

The known procedure for a remote service call in an environment such as this is shown in FIG. 3, and will be described in the following text:
I. The client 1 calls a local procedure which is provided by a proxy 3.
II. The proxy 3 uses the functionality implemented in the communication layer 4 to transmit the procedure call information via the LAN or the Internet 9 to the service provider 10.
III. The procedure call information is extracted in the communication layer 4 of the service provider 10 and locally call the procedure 5 which implements that service, formats the return value of the call, and transmits this to the communication layer 4 of the client 1.
IV. The communication layer 4 of the client 1 extracts the procedure return information and the corresponding local proxy 3 produces the return value as the result of the initial local procedure call to the client application 2.

By the use of SOAP (Simple Object Access Protocol), as described in http://www.w3.org/TR/soap12-part1/, linked to http (Hypertext Transfer Protocol), as described in ftp://ftp.isi.edu/in-notes/rfc2616.txt, as a-method for interchanging structured and type-based data, services can be made accessible to widely different applications within the so-called WWW beyond platform boundaries. In principle, the known method as well as the method described below are, however, independent of the protocol being used.

One major disadvantage of a generic implementation of remote method calls such as this is that these calls are many times more time-consuming and computation-intense than local function calls, or function calls in more closely coupled systems.

The invention is based on the object of specifying a system and a method for communication between remote objects, by means of which it is possible to reduce the communication complexity.

This object is achieved by a communications system which has the features specified in claim 1. An associated communication method and advantageous refinements are specified in further claims.

The invention accordingly proposes that the required communication complexity be reduced by arranging an optimization layer and a general proxy at the client end, and by introducing a general service at the service provider. These measures make it possible to achieve optimizations, for example by the grouping of calls.

The system or method allows the use of caches, alternative data formats and transmission protocols, as well as application-specific optimizations.

In environments which, for example, only loosely couple individual components beyond the boundaries of a local area network, it may be particularly desirable to group service calls when the fixed costs for a so-called round robin from the client to the service provider and back are very high in comparison to the costs of the transmission and processing of the actual service request and response. These costs are caused by the necessity to set up (often several) connections, the creation and transmission of protocol-specific message headers, and the initialization of components which process messages (for example of SOAP/XML-Parser, authentication and authorization) or transmit messages (for example HTTP connection or data compression). The invention results in an improvement in this situation since it allows optimizations to be introduced into the communication procedure independently of the creation of the services (web services) and proxies. In this case, there are no additional requirements on the procedure environment either of the service or of the client and proxy components, and the generic service and proxy components, in particular their interfaces, are not modified, thus advantageously achieving reusability and easy configurability.

The method according to the invention allows:
1. remote method calls to be suppressed, for example by using local caches for the response to information requests,
2. remote method calls to be delayed, for example the method calls which are required in object-oriented environments can be transmitted in order to monitor the lifetime of remote objects, whether this is by their explicit destruction (so-called destructor calls) or by the periodic determination of objects which are no longer being used (the so-called garbage collection), normally with a time delay from the client to the procedure environment of the remote object,
3. remote method calls to be grouped, for example in order to reduce the number of resource-intensive connection setting-up processes and to retrospectively deal with the subsequent requests in 1. and 2. when the opportunity arises,
4. the messages which contain the return values of remote method calls to have further information that is relevant for local use added to them, for example in order to cause the deletion of entries which have become invalid in local caches,
5. used transmission protocols or data formats to be used to decide, depending on the propagation time environment, for example in order to replace the resource-intensive SOAP/HTTP transmission by a more efficient form, if the nature of the connection allows this (Internet/LAN, and if present HTTP proxies and firewalls), and
6. communication to be initiated independently of calls from client applications for management, in particular updating and invalidation of the data in a cache, or piggyback information together with the transmission of call groups and the reverse transmission of responses from the service provider to be requested.

The method can be used in all environments in which generic service provider components and proxy components are available which encapsulate the formalities for formatting and transmission of a remote service call, and the corresponding response. For example, components such as these are offered by the Framework Class Library (FCL) of Microsoft.NET Platform, see J. Richter, Applied Microsoft.NET Framework Programming, Microsoft Press 2001, pages 21 to 24.

A further description of the invention and of its advantages is provided in the following text with reference to one exemplary embodiment, which is illustrated in the drawing figures, in which:

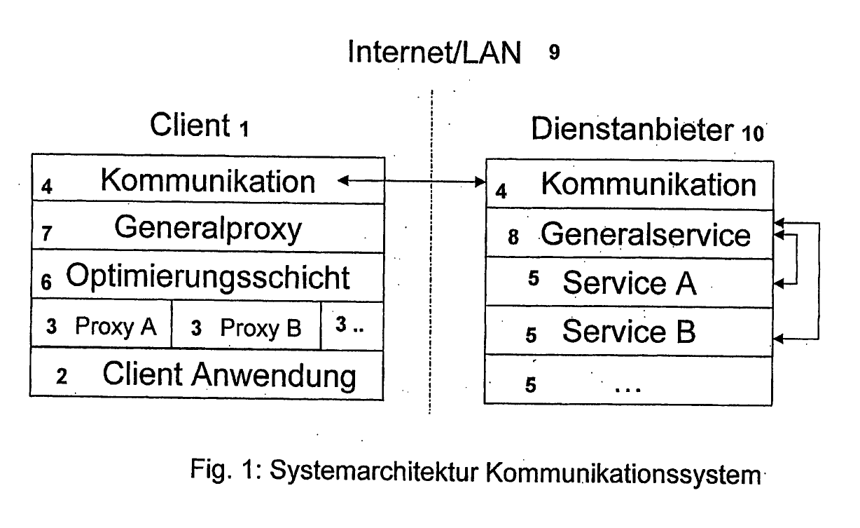

FIG. 1 shows the system architecture of a communications system according to the invention,

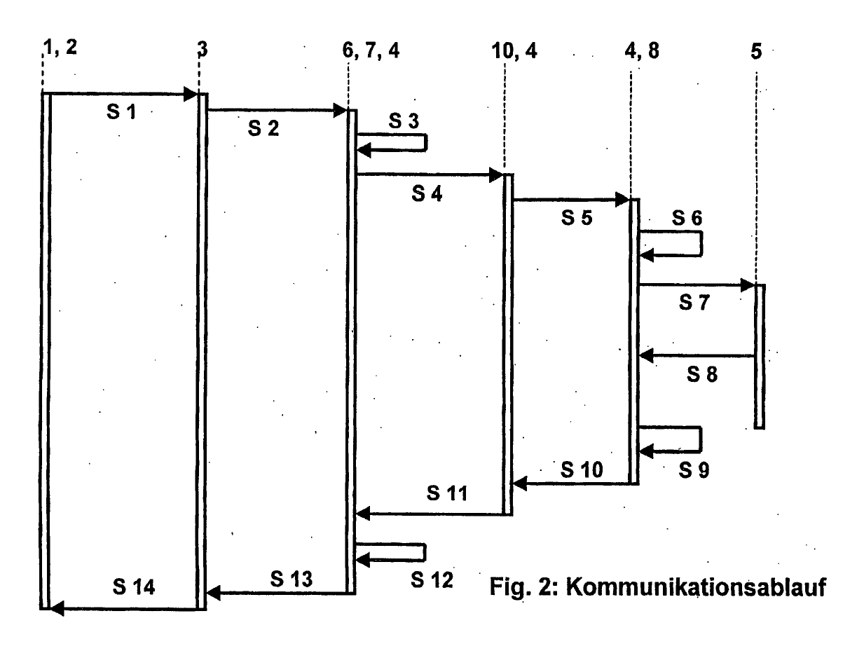

FIG. 2 shows a communications procedure according to the invention, and

FIG. 3 shows the system architecture of a communications system according to the prior art.

FIG. 1 shows the system architecture of a communications system according to the invention. For communication monitoring and optimization purposes, a further web service with a more general functionality, which is referred to as general service 8, is installed at the data provided 10 and in addition to the services 5 which are provided in an embodiment environment according to the prior art, as already described above with reference to FIG. 3. This general service 8 is able to switch one or more service requests to the original service provider, the services 5, and transmit one or more response messages to the remote client or clients 1.

A generic proxy for this additional web service is installed in a corresponding manner in the remote procedure environment, at the client 1, and is referred to as a general proxy 7. In addition, the client 1 contains an optimization layer 6, as an additional component. This offers communication and data formatting functions which are required for communication with the proxies 3, and to this extent replaces functions of the communication layer 4, but also with the addition of optimization capabilities. The optimization layer 6 may itself use the functionality of the communication layer 4, or some other implementation of the required functionality, by means of the general proxy 7.

Further information relating to the operation of the already mentioned components can be found in the following description of a communication procedure on the basis of FIG. 2. In FIG. 2, vertical bars symbolize the respectively used system components, whose numbering matches the respective component designation in FIG. 3. Procedure steps are annotated S1 to S14, and will be explained in the following text.

FIG. 2 shows a typical procedure for a service call in an extended environment according to the invention:

Step S1: The client 1 or the client application 2, calls a local procedure which is made available by a proxy 3.

Step S2: The proxy 3 uses the functionality implemented in the optimization layer 6 for transmission of procedure calls. The optimization layer 6 offers the proxy 3 an interface which is identical to the original communication layer, for this purpose.

Step S3: Provided that it has not been delayed and cannot be answered by a result in a cache in the optimization layer 6, the service call has service calls which are already available but have been delayed or else which have been sensible to handle in advance added to it in the optimization layer 6 (grouping of calls).

Step S4: This group of calls is transferred by a local call of the general proxy 7 to the generic communication layer 4 of the client 1, and is transmitted to the communication layer 4 of the service provider 10.

Step S5: The group is transferred to the general service 8 by a local call to the general service procedure.

Step S6: The general service procedure processes the service calls and produces their results. The general service 8 finds the required services 5 for this purpose in the step 6.

Step S7: Method call by the general service 8.

Step S8: Result return from the services 5 to the general service 8.

Step S9: Combination of the results by the general service 8 to form groups.

Step S10: Return of the result group to the communication layer 4. The group can have information to be transmitted additionally from the service provider to the optimization layer 6 of the client added to it.

Step S11: Transmission to the remote communication layer 4 and return from there to the general proxy 7, which produces the result as a local procedure return to the optimization layer 6.

Step S12: Evaluation of the results in the optimization layer 6.

Step S13: The information which has been supplied to the initial service request in addition to the response is evaluated and used in the optimization layer 6.

Step S14: The response to the initial request is transmitted via the generic proxy 3 to the client application 2, thus completing this example of a procedure.

In one specific implementation of the system, for example as a component within the .NET framework, the extension to an existing system by the addition of generic proxies and service providers can be provided by replacement of the client-end communication layer by the optimization layer 6 according to the invention with a communication layer 4 and the installation of the additional general proxy in parallel with the existing proxies. Optimizations which are independent of the application, such as the use of caches and the delaying of service calls, can thus be made available in a configurable form, without any implementation effort. Application-dependent optimizations can be introduced as modules at a defined interface of the optimization layer 6.

The general service 8 is implemented in a corresponding manner in parallel with the available services at the service provider end. The general service 8 includes a, cache of service-providing service instances, whose service methods are carried out by so-called reflection, that is to say on the basis of information about the destination, the name and the signature of the method. XML document instances in accordance with the SOAP specification or more bandwidth-efficient binary coding can be used for serialization and deserialization of the parameter and return objects relating to the method calls. In the case of SOAP (de)serialization, client-end types are associated with service-provider-end types on the basis of type attributes declared in the given proxy service pairs, and in the case of binary coding, a link is implemented between serialization and the type to be instantiated, on the basis of the requirements of the already found deserialization component.

The optimization and monitoring of the communication is transparent both for the user of the offered services and for their provider.

1. A system for communication between remote objects which are provided with service providers, whose methods can be accessed as web services, and client-end local proxies in a computer network, in particular the Internet or a LAN, with
a) a general service being installed in addition to the existing services (web services 5) at the service provider end and being designed to switch one or more service calls from a client to the available services, and to transmit one or more response messages to the client,
b) an optimization layer being implemented at the client end in addition to the other local proxies, and being designed to carry out client-end optimization and to combine call groups and, furthermore, with a general proxy being installed, which is designed to carry out grouped service calls, and to return response messages to the optimization layer.

2. The system as claimed in claim 1, wherein the optimization layer contains at least one cache, with whose aid service calls can be avoided or delayed.

3. The system as claimed in claim 2, wherein the client is designed by means of the optimization layer and the general proxy to automatically initiate a communication with a service provider, even without any call from a client application, in order to update stored information.

4. The system as claimed in claim 2, wherein the client is designed by means of the optimization layer and the general proxy to manage, in particular to update and invalidate, the data in the cache, to request piggyback information together with the transmission of call groups, and the reverse transmission of responses from the service provider.

5. A method for communication between remote objects which are provided with service providers, whose methods can be accessed as web services, and client-end local proxies in a computer network, in particular the Internet or a LAN, with
a general service being installed in addition to the existing services (web services 5) at the service provider end, and
an optimization layer in each case being implemented at the client end in addition to the other local proxies and containing a cache, and with a general proxy also being installed, and with
a) a plurality of calls to methods by client applications being passed by the respective proxy to the optimization layer, where they are combined to form a call group and are passed to a communication layer,
b) the call group being transmitted to the service provider, where the individual calls contained in the call group are passed by the general service to the respective corresponding services whose responses are combined and are transmitted back to the client in a grouped manner, and
c) the responses being evaluated in the optimization layer and being passed to the client application via the respective proxy.

6. The method as claimed in claim 5, wherein the optimization layer is designed to manage, in particular to update and invalidate, the data in the cache, to request piggyback information together with the transmission of call groups, and the reverse transmission of responses from the service provider.

7. The method as claimed in claim 5, wherein the optimization layer automatically initiates a communication with a service provider for management, in particular for updating and in validation, of the data in the cache, even without any call by a client application.

8. The method as claimed in claim 6, the optimization layer automatically initiates a communication with a service provider for management, in particular for updating and in validation, of the data in the cache, even without any call by a client application.
